(19) United States
(12) Patent Application Publication
(10) Pub. No.: US 2014/0277931 A1
(43) Pub. Date: Sep. 18, 2014

(54) VEHICLE POWER SYSTEMS AND METHODS EMPLOYING FUEL CELLS

(71) Applicant: Paul Stephen Crowe, Aubrey, TX (US)

(72) Inventor: Paul Stephen Crowe, Aubrey, TX (US)

(73) Assignees: PACCAR Inc, Bellevue, WA (US); Eaton Corporation, Cleveland, OH (US); Cummins Intellectual Properties, Inc., Minneapolis, MN (US)

(21) Appl. No.: 13/797,241

(22) Filed: Mar. 12, 2013

(51) Int. Cl. B60L 1/00

(52) U.S. Cl. CPC B60L 1/00
USPC 701/36

(57) ABSTRACT

Power systems and methods described herein can provide power system management and power delivery, among other functionality. The power systems and methods for a vehicle can employ a fuel cell, such as a Solid Oxide Fuel Cell (SOFC), as a power source in conjunction with another power sources, such as one or more vehicle batteries, capacitors, etc. The fuel cell can be conditionally used to provide power to the electrical system, thereby reducing the load on the vehicle batteries.

### BACKGROUND

Various vehicles such as long-haul trucks, boats and recreational vehicles are equipped with electronic equipment that requires power when the vehicle is underway and when it is parked. Such equipment are often referred to as “hotel loads,” and include heating and air conditioning, lighting, and appliances such as refrigerators, coffee makers and microwave ovens as well as so-called “infotainment systems”, which may include a television, an entertainment system, telematics, navigation, and/or the like.

Demands from these “hotel loads” occur both during engine on conditions, such as during operation of the truck over a route, or during engine off conditions, such as during mandatory rest periods, and no idle restrictions. Engine off conditions may also occur with newly developed hybrid powertrain equipped trucks.

Over the years, various arrangements have been proposed to supply power to vehicle hotel loads. Arrangements for powering hotel loads fall into two basic categories: (1) auxiliary power units (APUs) or generator sets; and (2) electrical power systems that are either powered by the vehicle batteries or are electrically connected to a conventional ac power outlet known as shore power.

The type of APU most commonly used is a motor-driven generator that utilizes diesel or other fuel such as gasoline or liquid petroleum. Such APUs provide an immediate source of electrical power for vehicle hotel loads and are capable of generating sufficient power for operating high demand devices such as conventionally designed heating and air conditioning units, microwaves, washer/dryers, etc. However, APUs—especially those driven by diesel or gasoline engines—are noisy and expel pollutants into the atmosphere. Further, conventional APUs are relatively heavy, have a relatively high initial cost and present issues from the standpoint of maintenance costs and scheduling.

As an alternative to motor driven APU's, systems that solely rely on the vehicle batteries have been proposed. These systems that use the vehicle batteries to supply hotel loads primarily consist of wiring to interconnect dc powered hotel loads to the vehicle batteries and an inverter unit for transforming dc current drawn from the batteries to ac current for any ac powered hotel loads. Such systems are superior to the use of an APU from the standpoint of initial cost, weight, maintenance considerations and noise. However, systems powered solely by the vehicle batteries often are not capable of supplying the needed amount of current for the vehicle hotel loads for a sufficient or desired period of time without discharging the vehicle batteries to a point at which the vehicle cannot be started, among other problems.

### SUMMARY

This summary is provided to introduce a selection of concepts in a simplified form that are further described below in the Detailed Description. This summary is not intended to identify key features of the claimed subject matter, nor is it intended to be used as an aid in determining the scope of the claimed subject matter.

In accordance with aspects of the present disclosure, a vehicle is provided. The vehicle includes one or more electrical devices each having a power load and a power source comprising one or more power storage devices and a fuel cell configured to supply power to the one or more electrical devices. In some embodiments, the one or more power storage devices include an aggregate state of charge (SOC). The vehicle also includes one or more data sources configured to provide data indicative of two or more of: vehicle history, vehicle location, vehicle operation, electrical device usage, weather data, and aggregate SOC of the one or more power storage devices. The vehicle further includes a controller configured to conditionally operate the fuel cell. The controller in some embodiments is configured to start the fuel cell based on the data provided by the one or more data sources and fuel cell operational data in order for the power source to meet the power loads of the one or more electrical devices.

In accordance with another aspect of the present disclosure, a computer implemented method of controlling a fuel cell is provided. The fuel cell is a part of a vehicle power source comprising one or more power storage devices having a state of charge (SOC). The vehicle power source is configured to supply power to one or more vehicle loads. The method includes calculating a power load demand schedule of the one or more vehicle loads over a predetermined time period of vehicle operation, calculating a predicted power storage level of the vehicle power source over said predetermined time period, and determining a start time for the fuel cell based on the calculated power load demand, the calculated predicted power storage level and fuel cell operational data in order for the vehicle power source to meet the power loads of the power load demand schedule over a predetermined time period of vehicle operation.

### DESCRIPTION OF THE DRAWINGS

The foregoing aspects and many of the attendant advantages of this invention will become more readily appreciated by reference to the following detailed description, when taken in conjunction with the accompanying drawings, wherein:

FIG. 1 is a functional block diagrammatic view of a vehicle employing one embodiment of a power system formed in accordance with aspects of the present disclosure;

FIG. 2 is a functional block diagrammatic view of another vehicle employing one embodiment of a power system formed in accordance with aspects of the present disclosure;

FIG. 3 is a functional block diagrammatic view of one embodiment of a power control formed in accordance with aspects of the present disclosure;

FIG. 4 is a flow diagram of one exemplary method implemented by the power system in accordance with aspect of the present disclosure; and

FIG. 5 is a graphic representation of several aspects of the present disclosure.

### DETAILED DESCRIPTION

The detailed description set forth below in connection with the appended drawings where like numerals reference like elements is intended as a description of various embodiments of the disclosed subject matter and is not intended to represent the only embodiments. Each embodiment described in this disclosure is provided merely as an example or illustration and should not be construed as preferred or advantageous over other embodiments. The illustrative examples provided herein are not intended to be exhaustive or to limit the claimed subject matter to the precise forms disclosed. Similarly, any steps described herein may be interchangeable with other steps, or combinations of steps, in order to achieve the same or substantially similar result.

Prior to discussing the details of various aspects of the present disclosure, it should be understood that the following description includes sections that are presented largely in terms of logic and operations that may be performed by conventional electronic components. These electronic components may be grouped in a single location or distributed over a wide area. It will be appreciated by one skilled in the art that the logic described herein may be implemented in a variety of configurations, including but not limited to, hardware, software, and combinations thereof. In circumstances were the components are distributed, the components are accessible to each other via communication links.

In the following description, numerous specific details are set forth in order to provide a thorough understanding of exemplary embodiments of the present disclosure. It will be apparent to one skilled in the art, however, that many embodiments of the present disclosure may be practiced without some or all of the specific details. In some instances, well-known process steps have not been described in detail in order not to unnecessarily obscure various aspects of the present disclosure. It will be appreciated that embodiments of the present disclosure may employ any combination of features described herein.

The following description sets forth one or more examples of an electrical power system for vehicles and the like. The power systems and methods described herein can provide power system management and power delivery, among other functionality. Generally described, examples described herein are directed to power systems and methods for a vehicle that employ a fuel cell, such as a Solid Oxide Fuel Cell (SOFC), as a power source in conjunction with another power sources, such as one or more vehicle batteries, capacitors, etc. The fuel cell can be conditionally used to provide power to the electrical system, thereby reducing the load on the vehicle batteries.

In some examples described herein, the electrical power system, based on information from a combination of data sources, operates the power system in order to meet the operational needs of the vehicle. Some of the information that may be collected and/or utilized by the power systems and methods include but are not limited to hours of vehicle operation, historical driver operation data, load data, GPS location and optional topography data, weather data, etc., and fuel cell characteristic data, such as power output ramp curve data, operational temperature data, etc. In some embodiments, the fuel cell is started in advance of full load demand of the vehicle so that the fuel cell is capable of providing full output capacity in order to at least meet such demand.

Although exemplary embodiments of the present disclosure will be described hereinafter with reference to a heavy duty truck, it will be appreciated that aspects of the present disclosure have wide application, and therefore, may be suitable for use with many other types of vehicles, including but not limited to light and medium duty vehicles, passenger vehicles, motor homes, buses, commercial vehicles, marine vessels, etc. Accordingly, the following descriptions and illustrations herein should be considered illustrative in nature, and thus, not limiting the scope of the present invention, as claimed.

As briefly described above, embodiments of the present disclosure are directed to power systems and methods suitable for use in a vehicle. FIG. 1 schematically shows a vehicle 20, such as a Class 8 tractor, that comprises a powertrain system 24. In the embodiment shown in FIG. 1, the powertrain 24 includes an internal combustion engine 26, a transmission 32, and a clutch assembly 36. The transmission 32 may be a manual transmission, an automated manual transmission, or an automatic transmission that includes multiple forward gears and a reverse gear operatively connected to an output shaft 42. The clutch assemblies 36 may be positioned between the internal combustion engine 26 and the transmission 32 to selectively engage/disengage the internal combustion engine 26 from the transmission 32. In use, the internal combustion engine 26 receives fuel from a fuel source 46 and converts the energy of the fuel into output torque. The output torque of the engine is converted via the transmission 32 into rotation of the output shaft 42.

The vehicle 20 also includes at least two axles such as a steer axle 50 and at least one drive axle, such as axles 52 and 54. The output shaft 42 of the transmission 32, which may include a vehicle drive shaft 46, is drivingly coupled to the drive axles 52 and 54 for transmitting the output torque generated by the engine 26 to the drive axles 52 and 54. The steer axle 50 is operatively coupled to a power steering system 60. In one embodiment, the power steering system 60 includes an electrically driven steering pump. The steer axle 50 supports corresponding front wheels 66 and the drive axles 52 and 54 support corresponding rear wheels 68, each of the wheels having service brake components 70. In some embodiments, the service brake components include air brake components of the air brake system 72, such as an electrically driven compressor, compressed air supply/return lines, brake chambers, etc. The service brake components 70 may also include wheel speed sensors, electronically controlled pressure valves, and the like, to effect control of the vehicle braking system.

The vehicle 20 may further include a cab mounted operator interface, such as a control console 84, which may include any of a number of output devices 88, such as lights, graphical displays, buzzers, speakers, gages, and the like, and various input devices 90, such as toggle switches, push button switches, potentiometers, or the like. In some embodiments, the vehicle may further include cab or sleeper mounted electrical systems 92, sometimes referred to as “house loads”, including an infotainment system 94, an auxiliary A/C unit 96, and/or other appliances 98 of convenience, such as a microwave, a coffee maker, electrical outlets for laptops, etc. In some embodiments, the infotainment system includes a navigational device having GPS or other location capability, CD/DVD or other audio/visual functionality, and optional communications system, including RF and IR based communication links. The RF capabilities of the infotainment system may include but are not limited to 802.x (e.g., 802.11, 802.15, 802.16, etc.), cellular, and Bluetooth/nearfield protocols, among others.

In order to start the internal combustion engine, and to provide power to the control console 84 and other cab and/or sleeper mounted electrical systems 92, etc., the vehicle 20 also includes a power system 100. The power system 100 in one embodiment includes a power control 120 and electrical energy source 124. The electrical energy source 124 may include electrical energy storage in the form of one or more batteries 126, one or more capacitors 128, and combinations thereof, etc. The electrical energy source 124 also includes a fuel cell 130, such as a solid oxide fuel cell (SOFC), to provide an additional source of electrical power for the power system 100. The SOFC in one embodiment may be capable of outputting up to about 5 kilowatts of power. The batteries 126 can be of the lead acid, NiCd, Lithium-ion type or can include any currently known or future developed rechargeable battery technology. The batteries may include starting batteries, deep cycle batteries, combinations thereof, etc. In some embodiments, the power system may include one or more primary batteries for starting the internal combustion engine and one or more auxiliary batteries for providing power to the “house” loads, among others, during engine on and engine off conditions. In this embodiment, the auxiliary batteries may be combined with the capacitors 128, the fuel cell 130, etc., in order to form an APU or the like.

As will be described in more detail below, the power control 120 in some embodiments can be used to manage the distribution of power to the associated loads of the vehicle. Further as will be described in more detail below, the power control 120 may include one or more algorithms that predict energy demands of the vehicle systems, determine the energy storage levels of the electrical energy storage, and operate the power system in order to supply power to the systems of the vehicle 20.

The power system 100 of the vehicle may also include one or more DC/DC converters to supply direct current to any suitable DC load, and may optionally include an inverter to supply alternating current to any suitable AC load. In some embodiments, the DC/DC converter reduces the voltage it receives from electrical energy storage 124 and/or fuel cell 130, and outputs power at this lower voltage to the appropriate loads. The D/C to D/C converter or inverter can output power to other electrical devices on the vehicle 20, including electric pumps, electric compressors, of the air brake system 72, the power steering system 60, or other vehicle systems, such as an electric PTO, etc., as will be described in more detail below. To aid in the distribution of power, additional components may be used, which are not shown but well known in the art, including distribution blocks, distribution panels, fuse blocks, relays, and/or the like.

While the vehicle 20 of FIG. 1 employs a powertrain utilizing an internal combustion engine as the vehicle motive force, the vehicle 20 depicted in FIG. 1 represents only one of the many possible applications for the systems and methods of the present disclosure. It should be appreciated that aspects of the present disclosure transcend any particular type of land or marine vehicle and any type of powertrain. For example, the vehicle may employ a hybrid powertrain 122, as depicted in FIG. 3. FIG. 3 illustrates a hybrid powertrain of parallel-type, although hybrid powertrains of the serial-type, or combined hybrid configurations (i.e., hybrids that operate in some manner as a parallel hybrid and a serial hybrid) may also be employed.

In the embodiment shown in FIG. 2, the hybrid powertrain 122 includes an internal combustion engine 26, an electric motor/generator 28, a power transfer unit 30, and a transmission 32. In use, the electric motor generator 28 can receive electrical energy from the power system 100 via a high voltage DC bus 40 and converts the electrical energy into output torque. The electric motor generator 28 can also operate as a generator for generating electrical energy to be stored in the electrical energy storage. A regenerative braking state of vehicle operation may also be provided by the power transfer unit 30, as known in the art.

Turning now to FIG. 3, there is shown in block diagrammatic form one example of the power control 120 formed in accordance with aspects of the present disclosure. As best shown in FIG. 3, the power control 120 includes a controller 210 connected in electrical communication with a plurality of data sources 220. As will be described in more detail below, the data sources 220 may include but are not limited to navigation equipment, communications device, on-board sensors, and/or the like. It will be appreciated that the controller 210 can be connected directly (wired or wirelessly) to the plurality of data sources 220 or indirectly via a CAN 240. Those skilled in the art and others will recognize that the CAN 240 may be implemented using any number of different communication protocols such as, but not limited to, Society of Automotive Engineer's (“SAE”) J1587, SAE J1922, SAE J1939, SAE J1708, and combinations thereof. The controller may also communicate with other electronic components of the vehicle 20 via the CAN 240 for collecting data from other electronic components to be utilized by the controller 210, and as such, can also be considered in some embodiments as data sources 220. For example, the controller 210 may receive data from one or more of an engine controller, a transmission controller, a brake system controller, among others. In operation, as will be described in more detail below, the controller 210 receives signals from the data sources 220, processes such signals and others, and depending on the processed signals, transmits suitable control signals for operating the power system 100, including the fuel cell 130.

In several embodiments, the controller 210 may contain logic rules implemented in a variety of combinations of hardware circuitry components and programmed microprocessors to effect control of the power system 100. To that end, as further illustrated in FIG. 3, one suitable embodiment of the controller 210 includes a memory 262, a processor 268, and a power control module 280 for providing functionality to the power control 120. The memory 262 may include computer readable storage media in read-only memory (ROM), random-access memory (RAM), and keep-alive memory (KAM), for example. The KAM may be used to store various operating variables while the processor 268 is powered down. The computer-readable storage media may be implemented using any of a number of known memory devices such as PROMs (programmable read-only memory), EPROMs (electrically PROM), EEPROMs (electrically erasable PROM), flash memory, or any other electric, magnetic, optical, or combination memory devices capable of storing data, including fuel cell operational data 282. In some embodiments, the controller 210 may include additional components including but not limited to a high speed clock, analog to digital (A/D) and digital to analog (D/A) circuitry, input/output circuitry and devices (I/O) and appropriate signal conditioning and buffer circuitry.

As used herein, the term processor is not limited to integrated circuits referred to in the art as a computer, but broadly refers to a microcontroller, a microcomputer, a microprocessor, a programmable logic controller, an application specific integrated circuit, other programmable circuits, combinations of the above, among others. In one embodiment, the processor 268 executes instructions stored in memory 262, such as power control module 280, to manage the load demand of the vehicle systems, and in turn, control the operation of the fuel cell 130.

The power control module 280 may include a set of control algorithms, including resident program instructions and calibrations stored in one of the storage mediums and executed to provide desired functions. Information transfer to and from the power control module 280 can be accomplished by way of a direct connection, a local area network bus and a serial peripheral interface bus. The algorithms may be executed during preset loop cycles such that each algorithm is executed at least once each loop cycle. Algorithms stored in the non-volatile memory devices are executed by the processor to monitor inputs from the sensing devices and other data transmitting devices or polls such devices for data to be used therein. Loop cycles are executed at regular intervals, for example each 3.125, 6.25, 12.5, 25 and 100 milliseconds during ongoing operation of the vehicle. Alternatively, algorithms may be executed in response to the occurrence of an event.

Still referring to FIG. 3, the processor 268 communicates with various data sources 220 directly or indirectly via an input/output (I/O) interface 286 and suitable communication links. The interface 286 may be implemented as a single integrated interface that provides various raw data or signal conditioning, processing, and/or conversion, short-circuit protection, and/or the like. Alternatively, one or more dedicated hardware or firmware chips may be used to condition and process particular signals before being supplied to the processor 268. In some embodiments, the signals transmitted from the interface 286 may be suitable digital or analog signals to control the fuel cell 130.

As shown in FIG. 3, the controller 210 is a separate controller dedicated to the power system 100. However, it will be appreciated that the controller 210 may be a power control module, which could be software embedded within an existing on-board controller, such as the engine controller, a general purpose controller, etc.

As briefly described above, the data sources 220 can include but are not limited to on-board sensors, a navigation/GPS device, a communications device, data stores, etc. These data sources and others in some embodiments may be part of the infotainment system 94, control console 84, etc., described above. The data supplied from these data sources 230 and others may generally or specifically relate to vehicle operating parameters, operator driving trends and accessory (e.g., house load) usage patterns and characteristics, and external parameters, including present vehicle navigation, traffic patterns, weather data, among others.

Referring now to FIG. 4, there is shown a flow diagram of one example of method carried out by the power system 100, and in some embodiments, carried out by one or more control modules, such as the power control module 280, when executed by the processor 268. As shown in FIG. 4, the method begins at block 400, and at block 404, the power load demand of the vehicle 20 is predicted over a predetermined time, route, etc. Generally, the power load demand can be predicted during engine on and/or engine off conditions. In that regard, in some embodiments, via data sources 220 and others, various states of vehicle operating parameters, operator driving trends and accessory (e.g., “house loads,” etc) usage patterns, and external parameters, including present vehicle navigational data, traffic patterns, weather data, among others, are monitored. From monitoring any combination of these various parameters, a predicted power load demand for the vehicle over time is calculated, referred to herein as the predicted power load demand schedule, an example of which is shown graphically in FIG. 5 as 510.

The predicted power load demand schedule, as represented by line 510, is an aggregate of the power demand from the various vehicle subsystems during vehicle operation. These subsystems may include but are not limited to powertrain 24, control console 84, “house loads” in the form of infotainment systems, appliances (coffee maker, microwave, refrigerator, cook top, washer/dryer, power outlets, etc.) and other electrically powered devices (e.g., heaters, A/C units, air compressors, electric PTOs, etc.). In some embodiments, such as those employing a hybrid powertrain, the predicted power demand schedule also includes upcoming vehicle propulsion power requirements by the electric drive motors 28, etc., which may be determined with the assistance of vehicle navigation data, operator driving patterns, etc.

Operator driving patterns in some embodiments may include an average power demand, a ratio between vehicle stop time to the total driving time, etc. In other embodiments, the operator driving pattern is predicted using a driving pattern recognition function based on statistical driving cycle information that can be developed during ongoing operation of the vehicle 20. This may include monitoring operator driving patterns to derive statistical driving pattern information from historical driving cycle information. In one or more embodiments, usage patterns of house loads may also be taken into consideration when calculating the predicted power load demand schedule. Again, this may be average power demand, or predicted power demand based on historical data, etc. Further, weather data can be taken into consideration regarding the use of A/C systems, auxiliary lighting, power take-offs, etc.

From block 404, the method proceeds to block 406, where the power storage levels of the electrical energy storage 124 are predicted over the same time period as the predicted power load demand schedule. In some embodiments, the predicted power storage levels is an average state of charge (SOC) of the electrical energy storage over time, an example of which is shown graphically in FIG. 5 as 514 and 518. As best shown in FIG. 5, the graph illustrates the average SOC (at 50% and 80%) of the electrical energy storage in dashed lines.

In other embodiments, the predicted power storage levels are determined by monitoring the electrical energy storage and predicting a state-of-charge trajectory for the electrical energy storage, which may include one of a charge-sustaining strategy and a charge-depleting strategy. In some embodiments, vehicle navigation data and other data can be additionally or alternatively used to predict potential power source recharging events via regenerative braking, excess alternator amperage, among others. Frequency and duration of such recharging events may impact the predicted power storage levels. It will be appreciated that in some embodiments, the output of one or more engine driven alternators may also be taken into consideration when predicting the power storage levels of the power storage device.

Next, the method proceeds to block 408, where the operation schedule of one or more components of the power system 100 during engine on and/or engine off conditions is determined. In that regard, one or more components of the power system 100 may be controlled based on the results of the predictive load storage levels and the predictive power load schedule from blocks 406 and 404, respectively.

In one embodiment, the fuel cell operational and characteristic data stored in memory 262 is used in conjunction with the results of the predictive load storage levels and the predictive power load schedule from blocks 406 and 404, respectively, in order to operate (e.g., turn on; turn off, cycle, etc.) the fuel cell. For example, in some embodiments, the predicted load demand may approach or even exceed a current (e.g., amps) level corresponding to a desired minimum SOC level (e.g., 50%) of the electrical energy storage, which may in some cases affect the short-term and long term operation thereof. Accordingly, to alleviate the possible power shortage or potential harmful operating conditions of the electrical energy storage at low SOC's and to provide a more balanced supply of power, the fuel cell may be operated at strategic times during vehicle operation. The fuel cell, as known in the art, can be started by delivery of oxygen to the cathode side and delivery of fuel to the anode side of the fuel cell.

It is known that fuel cells, and particular, SOFC's, do not output maximum power at the start, but take time to “ramp up” to maximum power. For fuel cells like SOFC's, this ramp up time can occur while the fuel cell material, typically of the ceramic type, is brought up to an efficient operating temperature.

Due to such inherent ramp up power curves of fuel cells, and in particular, solid oxide fuel cells, the power module 280 in some embodiments, when executed by the processor 268, determines a time Tₘₐₓ when it is desirable for the solid oxide fuel cell to be operating, for example, at its maximum output. And in turn, the power module 280 in some embodiments, when executed by the processor 268, signals the fuel cell at the appropriate time preceding time Tₘₐₓ, designated as Tₛₜₐᵣₜ in FIG. 5, given its ramp up power characteristics represented graphically by curves 522, and/or other data such as fuel cell operating parameters (e.g., fuel delivery rates, oxygen delivery rates, operating temperatures, etc.). It will be appreciated that in some embodiments, the timing is to allow the fuel cell to reach maximum output prior to possible need. In other embodiments, the control can advantageously use the power characteristics in order to time the start of the fuel cell to more closely match the additional demand. The fuel cell may then be stopped at times during the predictive power load schedule in order to conserve fuel, etc., and restarted when desired.

The principles, representative embodiments, and modes of operation of the present invention have been described in the foregoing description. However, aspects of the present invention which are intended to be protected are not to be construed as limited to the particular embodiments disclosed. Further, the embodiments described herein are to be regarded as illustrative rather than restrictive. It will be appreciated that variations and changes may be made by others, and equivalents employed, without departing from the spirit of the present invention. Accordingly, it is expressly intended that all such variations, changes, and equivalents fall within the spirit and scope of the present invention, as claimed.

The embodiments of the invention in which an exclusive property or privilege is claimed are defined as follows:

1. A vehicle, comprising:
one or more electrical devices each having a power load;
a power source comprising one or more power storage devices and a fuel cell configured to supply power to the one or more electrical devices, the one or more power storage devices having an aggregate state of charge (SOC);
one or more data sources configured to provide data indicative of two or more of: vehicle history, vehicle location, vehicle operation, electrical device usage, weather data, and aggregate SOC of the one or more power storage devices; and
a controller configured to conditionally operate the fuel cell, wherein the controller is configured to start the fuel cell based on the data provided by the one or more data sources and fuel cell operational data in order for the power source to meet the power loads of the one or more electrical devices.

2. The vehicle of claim 1, wherein the controller is configured to determine a power load demand schedule over a predetermined time period of vehicle operation and a predicted power storage level over said predetermined time period.

3. The vehicle of claim 2, wherein the power load demand schedule is an average power load demand based on historical operational data of the vehicle.

4. The vehicle of claim 2, wherein the power load demand schedule is predicted over the predetermined time period based on data provided by the data sources.

5. The vehicle of claim 1, wherein the fuel cell includes a solid oxide fuel cell.

6. The vehicle of claim 1, wherein the one or more power storage devices include one or more selected from a battery and a capacitor.

7. A computer implemented method of controlling a fuel cell, the fuel cell being a part of a vehicle power source comprising one or more power storage devices having a state of charge (SOC), the vehicle power source configured to supply power to one or more vehicle loads, the method comprising:
calculating a power load demand schedule of the one or more vehicle loads over a predetermined time period of vehicle operation;
calculating a predicted power storage level of the vehicle power source over said predetermined time period;
determining a start time for the fuel cell based on the calculated power load demand, the calculated predicted power storage level and fuel cell operational data in order for the vehicle power source to meet the power loads of the power load demand schedule over a predetermined time period of vehicle operation.

8. The method of claim 7, wherein the power load demand schedule is an average power load demand based on historical operational data of the vehicle.

9. The method of claim 7, wherein the power load demand schedule is predicted over the predetermined time period based on data indicative of two or more of vehicle history, vehicle location, vehicle operation, electrical device usage, weather data, and aggregate SOC of the vehicle power source.

10. The method of claim 7, wherein the predicted power storage level is an average state of charge (SOC) of the vehicle power over time.
